(19) United States
(12) Patent Application Publication
(10) Pub. No.: US 2009/0098869 A1
(43) Pub. Date: Apr. 16, 2009

(54) POWER SAVING

(75) Inventors: Jeffery Torrance, Cambridge (GB); James Digby Yarlet Collier, Suffolk (GB)

Correspondence Address: FITZPATRICK CELLA HARPER & SCINTO, 30 ROCKEFELLER PLAZA, NEW YORK, NY, 10112, US

(73) Assignee: UBINETICS (VPT) LIMITED, CAMBRIDGESHIRE (GB)

(21) Appl. No.: 12/194,214

(22) Filed: Aug. 19, 2008

(30) Foreign Application Priority Data
Sep. 21, 2007 (GB) 0718498.9

(51) Int. Cl. H04W 48/20; H04M 1/00

(52) U.S. Cl. 455/426.1; 455/574

(57) ABSTRACT

A method of reducing the power consumption of a multi-mode mobile telecommunications device, the method comprising receiving information relating to the location of the mobile telecommunications device and adjusting the frequency with which the mobile telecommunications device searches for a wireless access point according to the information so received.

### FIELD OF THE INVENTION

The present invention relates to a method of reducing the power consumption of a multi-mode mobile telecommunications device, and to a multi-mode mobile telecommunications device which uses such a method.

### BACKGROUND OF THE INVENTION

The increasingly widespread availability of high-speed domestic and commercial internet connections has led to an increase in the use of the internet to make and receive telephone calls using protocols such as Voice over Internet Protocol (VoIP). Typically, such calls are made using a telephone handset connected to an internet-connected computer, with the computer converting a signal representative of the user's speech into data packets which are transmitted over the internet to the recipient of the call.

A disadvantage of this system is that an internet-connected computer is required to make a VoIP call, thus effectively limiting the location of a user when making or receiving a call. However, it is possible to alleviate this problem by using a wireless network, such as an IEEE 802.11 compliant network. Such networks typically have access points to which any compatible device can connect, thus providing wireless access to the internet. Wireless networks are provided in many public areas such as libraries, airport departure lounges, hotels, coffee shops and the like, allowing members of the public to access the internet using appropriate devices such as laptop computers and portable digital assistants. Domestic wireless networks are also increasingly prevalent.

The concept of Fixed-Mobile Convergence (FMC) takes advantage of the increasing availability of wireless networks. FMC uses multi-mode mobile telecommunications devices such as telephones, which can connect to a cellular mobile telecommunications network such as a GSM (2G) or 3GPP network and to a wireless network such as an IEEE 802.11 compliant network. In normal operation, a multi-mode telephone is connected to the cellular network, and calls made to or from the telephone use the cellular network. However, if the telephone detects that a wireless network is available, it connects to that network, and calls made to or from the telephone use VoIP or another suitable protocol. As the user of the telephone moves out of range of the wireless network, the telephone switches back to using the cellular network.

The use of multi-mode mobile telecommunications devices and wireless networks for making and receiving calls offers a number of advantages. When the device is connected to a wireless access point, which is generally only a short distance away, the amount of power required to transmit signals to the wireless access point is reduced in comparison with a cellular network. Moreover, many wireless networks can be accessed free of charge, and thus using them to make telephone calls can lead to significant savings in the cost of making calls.

Although the power required to transmit signals to a wireless access point is less than that required to transmit signals to a base station of a cellular network, multi-mode mobile telecommunications devices such as telephones suffer from poor battery life. This can be attributed to the power consumption involved in frequently searching for a wireless access point to connect to.

### SUMMARY OF THE INVENTION

According to a first aspect of the invention, there is provided a method of reducing the power consumption of a multi-mode mobile telecommunications device, the method comprising receiving information relating to the location of the mobile telecommunications device and adjusting the frequency with which the mobile telecommunications device searches for a wireless access point according to the information so received.

By adjusting the searching behaviour of the mobile telecommunications device depending upon its location, energy can be conserved and thus the battery life of the mobile telecommunications device can be increased. Thus, for example, the mobile telecommunications device may conserve energy by only searching for a wireless access point in those locations where there is most likely to be one.

The information relating to the location of the mobile telecommunications device may comprise information relating to a cell of a cellular system serving the mobile telecommunications device.

The information may comprise a cell ID of the cell serving the mobile telecommunications device.

The information may comprise a base station ID of a base station of the cellular system.

Alternatively or additionally, the information relating to the location of the mobile telecommunications device may comprise information received from one or more positioning systems.

The positioning system or systems may comprise a global navigation satellite system (GNSS).

Examples of such systems include the NAVSTAR Global Positioning System (GPS), GLONASS, Galileo, Beidou and IRNSS, although it will be appreciated that any suitable positioning system may be used in the method of the invention.

Alternatively, the positioning system or systems may comprise a terrestrial positioning system.

The terrestrial positioning system or systems may comprise a radio navigation system or a radiolocation system, such as an Enhanced Observed Time Difference (E-OTD) system.

The information relating to the location of the mobile telecommunications device may be received indirectly. For example, the information relating to the location of the mobile telecommunications device may comprise information received from a location-aware device in the vicinity of the mobile telecommunications device.

The method may further comprise comparing the location information to a predefined list of locations, each location on the list being associated with a wireless access point.

Thus, if the location information received corresponds to a location on the list, the frequency with which the mobile telecommunications device searches for a wireless access point may be increased.

Conversely, if the location information received does not correspond to a location on the list, the frequency with which the mobile telecommunications device searches for a wireless access point may be reduced.

The list may comprise a look-up table stored by the mobile telecommunications device.

Alternatively, the list may comprise a look-up table stored externally of the mobile telecommunications device.

According to a second aspect of the invention, there is provided a multi-mode mobile telecommunications device comprising a cellular communications subsystem and a wireless communications subsystem, the mobile telecommunications device being configured to receive information relating to its location and to adjust the frequency with which it searches for a wireless access point according to the information so received.

The information relating to the location of the mobile telecommunications device may comprise information relating to a cell of a cellular system serving the mobile telecommunications device.

The information may comprise a cell ID of the cell serving the mobile telecommunications device.

The information may comprise a base station ID of a base station of the cellular system.

The information relating to the location of the mobile telecommunications device may comprise information received from one or more positioning systems.

The positioning system or systems may comprise a global navigation satellite system (GNSS).

Examples of such systems include the NAVSTAR Global Positioning System (GPS), GLONASS, Galileo, Beidou and IRNSS, although it will be appreciated that any suitable positioning system may be used by the telecommunications device.

The positioning system or systems may comprise a terrestrial positioning system.

The terrestrial positioning system may comprise a radio navigation system or a radiolocation system, such as an Enhanced Observed Time Difference (E-OTD) system.

The information relating to the location of the mobile telecommunications device may be received indirectly. For example, the information relating to the location of the mobile telecommunications device may comprise information received from a location-aware device in the vicinity of the mobile telecommunications device.

The mobile telecommunications device may be configured to compare the location information to a predefined list of locations, each location on the list being associated with a wireless access point.

For example, if the location information received corresponds to a location on the list, the frequency with which the mobile telecommunications device searches for a wireless access point may be increased.

Conversely, if the location information received does not correspond to a location on the list, the frequency with which the mobile telecommunications device searches for a wireless access point may be reduced.

The list may comprise a look-up table stored by the mobile telecommunications device.

Alternatively, the list may comprise a look-up table stored externally of the mobile telecommunications device.

According to a third aspect of the invention, there is provided a computer program for causing processing apparatus to perform the method of the first aspect of the invention.

### BRIEF DESCRIPTION OF THE DRAWINGS

Embodiments of the invention will now be described, strictly by way of example only, with reference to the accompanying drawings, of which

FIG. 1 is a schematic representation of a multi-mode mobile telephone which can connect to a cellular network and to a wireless network;

FIG. 2 is a flow chart illustrating the operation of a known multi-mode mobile telephone.

FIG. 3 is a flow chart illustrating the operation of a multi-mode mobile telephone according to the present invention.

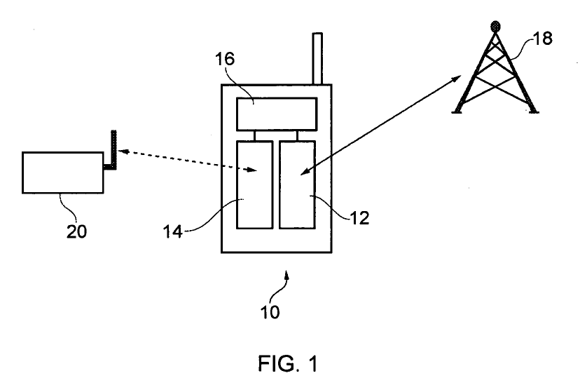

Referring firstly to FIG. 1, a multi-mode mobile telecommunications device is shown generally at 10. In this example, the telecommunications device is a multi-mode mobile telephone, but it will be appreciated that the invention is equally applicable to any multi-mode mobile telecommunications device, for example a portable digital assistant (PDA). The telephone 10 has a cellular communications subsystem 12 and a wireless communications subsystem 14, each of which is connected to a common subsystem 16 which performs common functions of a mobile telephone, such as digitising speech and the like. The telephone 10 is served by a base station 18 of a cell of a cellular network such as a GSM network or a 3GPP network, to allow the telephone 10 to make and receive calls using the cellular communications subsystem 14, and this is the default mode of operation of the telephone 10. However, the telephone 10 is also able to connect to a wireless access point 20 of a wireless network such as an IEEE 802.11 compliant network, allowing the telephone 10 to connect to the internet and to make calls using VoIP or any other suitable protocol, using the wireless communications subsystem 14.

The term “wireless network” as used herein refers to a network which enables a suitably-configured device to access the internet without a wired connection. Thus, the term “wireless network” encompasses networks compliant with the IEEE 802.11 standard, Bluetooth®, UWB and other wireless communications systems.

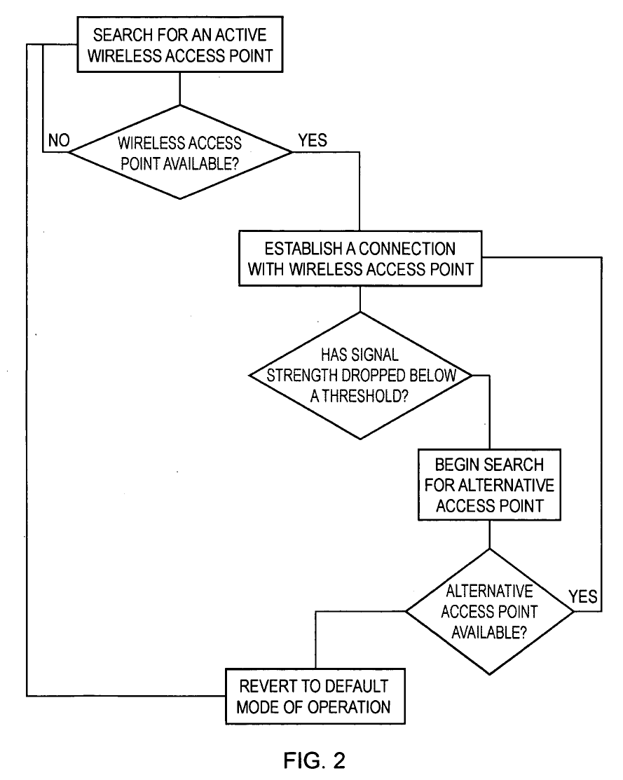

FIG. 2 illustrates the process used by a known multi-mode telephone 10 to determine if it can connect to a wireless network. The telephone 10 periodically searches for an available wireless access point 20, by scanning for active channels within one or more frequency bands in which wireless networks are known to operate. If no wireless access point 20 is available, the telephone 10 remains in its default mode of operation, using the cellular communications subsystem 12 to make and receive calls, via the cellular network, and the telephone 10 continues periodically to search for an active wireless access point 20.

If a wireless access point 20 is detected, the telephone 10 establishes a connection with it, and calls can be made and received using VoIP or any other suitable protocol, using the wireless communications subsystem 14. In this mode of operation, the wireless communications subsystem 14 monitors the strength of signals received from the wireless access point 20, and once the received signal strength drops below a threshold, begins to search for an alternative wireless access point 20 which can provide a stronger signal. If no suitable alternative wireless access point 20 can be found, the telephone 10 switches back to its default mode of operation. The process of periodically searching for an active wireless access point 20 then starts again.

This periodic searching for an active wireless access point 20 is a significant drain on the battery of the telephone 10, as although only a small amount of power is required to perform the search, the search is carried out frequently, often without success.

The method of the present invention addresses this problem by using location information which is available to the telephone 10 to assess the likelihood that there is an active wireless access point 20 within range, and to adjust the frequency (i.e. the number of times in a given time period) with which the telephone 10 performs its search for an active wireless access point 20.

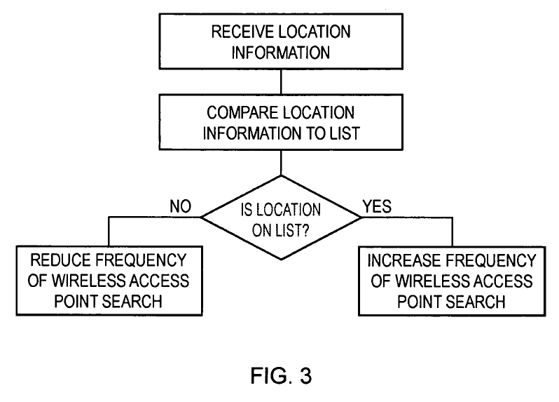

The flow diagram of FIG. 3 illustrates the method of the present invention. The multi-mode telephone 10 receives information relating to the current location of the telephone 10. This location information may be provided by a cellular network to which the telephone is connected. For example, the information relating to the location of the telephone may comprise a base station ID or a cell ID of a base station 18 or cell serving the mobile telephone 10. Alternatively, the location information may be provided by other means, for example as co-ordinates provided by a positioning system receiver built in to the telephone 10. The positioning system may be a global satellite navigation system such the NAVSTAR Global Positioning System (GPS), GLONASS, Galileo, Beidou and IRNSS or any other suitable system. The telephone 10 may include more than one positioning system receiver, such that location information may be provided by more than one system, with the information so received being used by the telephone 10 to determine its location accurately.

Additionally or alternatively, the positioning system may be ground based, for example a terrestrial location-determining network or a system using radiolocation or radio navigation technology, such as an Enhanced Observed Time Difference (E-OTD) system.

Location information may be also be provided indirectly to the telephone 10. For example, location information may be received or determined from one or more location-aware devices in the vicinity of the telephone 10, such as personal computers. In any case, the location information is either periodically or continuously updated, such that the telephone 10 always has a reasonably up to date indication of its own location.

The telephone 10 uses this location information to influence how or indeed whether it searches for an active wireless access point 20. In one example, the telephone 10 compares the location information to a list of known locations, which may be provided as a look-up table stored in the telephone's internal memory, or may be provided as a look-up table stored externally of the telephone 10, for example on a server or network accessible to the telephone 10. Each of the entries in the list corresponds to a location where there is known to be an active wireless access point 20. The list may also include additional information about the wireless access points 14 associated with each location, for example the frequency and/or channel at which each wireless access point 20 operates, or which was last used by the telephone 10 when connected to each access point 14, which information can be used to facilitate establishing a connection between the telephone 10 and the wireless access point 20, as will be described in more detail below.

If the location information received by the telephone 10 corresponds to an entry in the list, it is known that there is an active wireless access point 20 in that location. The telephone 10 thus increases the frequency with which the search for an active wireless access point 20 is carried out. Performing the search more often ensures that a connection to the active wireless access point 20 can be established as quickly as possible. To assist in this, the telephone 10 may retrieve the additional information about the wireless access point 20 from the list. Thus, if the list includes information about the frequency at which the wireless access point 20 operates, the telephone 10 may begin searching for a wireless access point 20 operating at that frequency. Similarly, if the list includes information about the channel that was used by the telephone 10 the last time it was connected to the access point 20, the telephone 10 may being the search at that channel.

If the location information received by the telephone 10 does not correspond to an entry in the list, the telephone 10 may reduce the frequency with which the search for an active wireless access point 20 is carried out. Performing the search less often reduces battery consumption.

In an alternative embodiment, the result of the comparison between the received location information and the list may be used as an input to a multiple-input algorithm of a known type, such as an adaptive thresholding algorithm, a weighted-random triggering algorithm or a neural network. In this way, the location of the telephone 10 influences the frequency with which the search for an active wireless access point 20 is carried out, but is not the sole factor involved. The use of such an algorithm assists in drawing a balance between reducing battery consumption by minimising the amount of searching carried out, and ensuring that a search is always carried out when an active wireless access point 20 is available.

It will be appreciated that for the method to be effective, the list must be populated with location information and information relating to the wireless access points available at each location. To populate the list, the telephone 10 may be “trained” by a user or automatically.

The user may manually cause the telephone 10 to enter a training mode, or the telephone 10 may use the first few days of use for training purposes. For example, the first time the telephone 10 is used may be at a user's home, which may be equipped with a wireless network having a wireless access point 20. The telephone 10 automatically detects this wireless access point 20, and adds the location, as defined by the base station or cell ID, positioning system co-ordinates or otherwise, to the list stored in the telephone's internal memory. This may be done automatically, or the user may be prompted to allow the addition. Further information about the wireless access point 20, such as the frequency or channel used, may also be stored.

When the telephone 10 is moved out of range of the wireless access point 20, it automatically begins searching for another wireless access point 20. During this time, the telephone 10 continues to receive location information. Thus, when another wireless access point 20 is located by the search, its location can be stored on the list.

Once the telephone 10 has been trained, it operates as described above. The telephone 10 may periodically be re-trained automatically, or the user may manually re-train it, for example when moving to a new home or place of work. The almost ubiquitous coverage provided by the cellular network or other location information system allows a detailed list of locations in which a wireless access point is available to be built up, which can be used by suitably-configured multi-mode telephones to achieve significant power savings.

It will be appreciated that the method of the present invention can be implemented in a variety of different ways. For example, the method may be implemented as a computer program configured to cause a processor of the mobile telephone 10 to carry out the method. Alternatively, the method may be carried out in hardware, or using an application specific integrated circuit (ASIC) or a suitably programmed microprocessor.

1. A method of reducing the power consumption of a multi-mode mobile telecommunications device, the method comprising receiving information relating to the location of the mobile telecommunications device and adjusting the frequency with which the mobile telecommunications device searches for a wireless access point according to the information so received.

2. A method according to claim 1 wherein the information relating to the location of the mobile telecommunications device comprises information relating to a cell of a cellular system serving the mobile telecommunications device.

3. A method according to claim 2 wherein the information comprises a cell ID of the cell serving the mobile telecommunications device.

4. A method according to claim 2 wherein the information comprises a base station ID of a base station of the cellular system.

5. A method according to claim 1 wherein the information relating to the location of the mobile telecommunications device comprises information received from a positioning system.

6. A method according to claim 5 wherein the positioning system comprises a global navigation satellite system.

7. A method according to claim 5 wherein the positioning system comprises a terrestrial positioning system.

8. A method according to claim 7 wherein the terrestrial positioning system comprises an Enhanced Observed Time Difference system.

9. A method according to claim 1 wherein the information relating to the location of the mobile telecommunications device is received indirectly.

10. A method according to claim 9 wherein the information relating to the location of the mobile telecommunications device comprises information received from a location-aware device in the vicinity of the mobile telecommunications device.

11. A method according to claim 1 further comprising comparing the location information to a predefined list of locations, each location on the list being associated with a wireless access point.

12. A method according to claim 11 wherein if the location information received corresponds to a location on the list, the frequency with which the mobile telecommunications device searches for a wireless access point is increased.

13. A method according to claim 11 wherein if the location information received does not correspond to a location on the list, the frequency with which the mobile telecommunications device searches for a wireless access point is reduced.

14. A method according to claim 11 wherein the list comprises a look-up table stored by the mobile telecommunications device.

15. A method according to claim 11 wherein the list comprises a look-up table stored externally of the mobile telecommunications device.

16. (canceled)

17. A multi-mode mobile telecommunications device comprising a cellular communications subsystem and a wireless communications subsystem, the mobile telecommunications device being configured to receive information relating to its location and to adjust the frequency with which it searches for a wireless access point according to the information so received.

18. A multi-mode mobile telecommunications device according to claim 17 wherein the information relating to the location of the mobile telecommunications device comprises information relating to a cell of a cellular system serving the mobile telecommunications device.

19. A multi-mode mobile telecommunications device according to claim 18 wherein the information comprises a cell ID of the cell serving the mobile telecommunications device.

20. A multi-mode mobile telecommunications device according to claim 19 wherein the information comprises a base station ID of a base station of the cellular system.

21. A multi-mode mobile telecommunications device according to claim 18 wherein the information relating to the location of the mobile telecommunications device comprises information received from a positioning system.

22. A multi-mode mobile telecommunications device according to claim 21 wherein the positioning system comprises a global navigation satellite system.

23. A multi-mode mobile telecommunications device according to claim 21 wherein the positioning system comprises a terrestrial positioning system.

24. A multi-mode mobile telecommunications device according to claim 23 wherein the terrestrial positioning system comprises an Enhanced Observed Time Difference system.

25. A multi-mode mobile telecommunications device according to claim 17 wherein the information relating to the location of the mobile telecommunications device is received indirectly.

26. A multi-mode mobile telecommunications device according to claim 25 wherein the information relating to the location of the mobile telecommunications device comprises information received from a location-aware device in the vicinity of the telecommunications device.

27. A multi-mode mobile telecommunications device according to claim 17, the mobile telecommunications device being configured to compare the location information to a predefined list of locations, each location on the list being associated with a wireless access point.

28. A multi-mode mobile telecommunications device according to claim 27 wherein if the location information received corresponds to a location on the list, the frequency with which the mobile telecommunications device searches for a wireless access point is increased.

29. A multi-mode mobile telecommunications device according to claim 27 wherein if the location information received does not correspond to a location on the list, the frequency with which the mobile telecommunications device searches for a wireless access point is reduced.

30. A multi-mode mobile telecommunications device according to claim 27 wherein the list comprises a look-up table stored by the mobile telecommunications device.

31. A multi-mode mobile telecommunications device according to claim 27 wherein the list comprises a look-up table stored externally of the mobile telecommunications device.

32. (canceled)

33. A computer program embodied on a computer-readable medium, the program having instructions which, when read by a processing apparatus, cause the processing apparatus to perform the method of claim 1.
